(19) United States
(12) Patent Application Publication
(10) Pub. No.: US 2026/0206787 A1
(43) Pub. Date: Jul. 23, 2026

(54) GREEN TEA LEAVES AND PRODUCTION METHOD FOR GREEN TEA LEAVES

(71) Applicant: Hitotsubo Chaen Co., Ltd., Tokyo (JP)

(72) Inventors: Natsuko WAKI, Kikugawa-shi, Shizuoka (JP); Masahito NAGAI, Kikugawa-shi, Shizuoka (JP)

(73) Assignee: Hitotsubo Chaen Co., Ltd., Tokyo (JP)

(21) Appl. No.: 19/142,976

(22) PCT Filed: Dec. 5, 2023
(86) PCT No.: PCT/JP2023/043465

§ 371 Date: Jun. 25, 2025

(30) Foreign Application Priority Data
Dec. 26, 2022 (JP) 2022-208366

(51) Int. Cl. A23F 3/14

(52) U.S. Cl. CPC A23F 3/14

(57) ABSTRACT

The present invention addresses the problem of improving the value of green tea or a green tea-related product. A finished tea 1 is for cold-water extraction, and a processed crude tea AP-1 includes: a processed crude tea AP-2 roasted to a first roasting degree by heating ST22-1; and a processed crude tea AP-2 roasted to a second roasting degree, which is higher than the first roasting degree, by heating ST22-2. The roasting degree of the processed crude tea AP-2 is lower than the roasting degree at which the processed crude tea AP-2 becomes roasted green tea. Consequently, the problem is solved.

### TECHNICAL FIELD

The present invention relates to green tea leaves and a method of producing green tea leaves.

### BACKGROUND ART

Conventionally, green tea has been produced using raw materials harvested from tea plants. For example, a technique has been proposed, in which raw tea leaves are impregnated with an aqueous solution containing amino acids and then subjected to heat treatment and drying to enhance the flavor and taste of the tea leaves (see, for example, Patent Document 1).

### CITATION LIST

### Patent Document

Patent Document 1: Japanese Unexamined Patent Application, Publication No. 2012-183064

### DISCLOSURE OF THE INVENTION

### Problems to be Solved by the Invention

However, in order to enhance the value of a luxury beverage, it is important not only to improve the aroma and taste but also to allow consumers to resonate with the characteristics of the luxury beverage. The properties such as aroma and taste of green tea and products related to green tea (hereinafter referred to as “green tea-related products”), as well as the distinctive features of green tea and green tea-related products, have not necessarily met consumer demands. In other words, there has been room for further improvement in the value of green tea and green tea-related products.

The present invention aims to enhance the value of green tea and green tea-related products.

### Means for Solving the Problems

In order to achieve the above object, one aspect of the green tea leaves of the present invention is:

green tea leaves for cold water extraction, including:
first green tea leaves of a first roasting level; and
second green tea leaves of a second roasting level higher than the first roasting level.

One aspect of the production method of the present invention is:
a method of producing green tea leaves for cold water extraction, including:
   a first roasting step of roasting tea leaves at a first roasting level,
   thereby obtaining first green tea leaves;
   a second roasting step of roasting tea leaves at a second roasting level higher than the first roasting level, thereby obtaining second green tea leaves; and
   a blending step of blending the first green tea leaves and the second green tea leaves.

### Effects of the Invention

According to the present invention, the value of green tea and green tea-related products can be enhanced.

### BRIEF DESCRIPTION OF THE DRAWINGS

FIG. 1 is a diagram illustrating an overview of the production process for finished tea leaves and teabags enclosing the finished tea leaves, according to one embodiment of the green tea leaves of the present invention;

FIG. 2 is a diagram illustrating characteristics of cold water extraction of the finished tea leaves illustrated in FIG. 1;

FIG. 3 is a schematic diagram illustrating the dried state and the extracted state of the teabag illustrated in FIG. 1; and

FIG. 4 is a diagram illustrating the preparation of parts and the blending in a selecting and blending process for the finished tea.

### PREFERRED MODE FOR CARRYING OUT THE INVENTION

The present invention relates to finished green tea for cold water extraction, teabags enclosing the finished tea, and a method of producing the same. Hereinafter, embodiments of the present invention will be described with reference to the drawings.

Here, “green tea” refers to a product that is manufactured or processed from raw materials harvested from tea plants, without undergoing the prescribed fermentation process for obtaining oolong tea or black tea. The term “green tea” includes “withered tea” that has undergone “withering”. “Withering” refers to a process in which harvested tea leaves are left in a well-ventilated area to wither, thereby enhancing the aroma. During this withering process, the tea leaves undergo slight fermentation, accentuating the unique aroma of the tea variety when finished into tea. “Withered tea” can be described as a “mildly fermented tea”. The term “green tea” also includes roasted green tea (hojicha).

Tea leaves used for extracting drinking green tea are referred to as “green tea leaves”. In this specification, “cold water” refers to “water at 25° C. or below”. The extraction of drinking green tea from green tea leaves using cold water is referred to as “cold water extraction”.

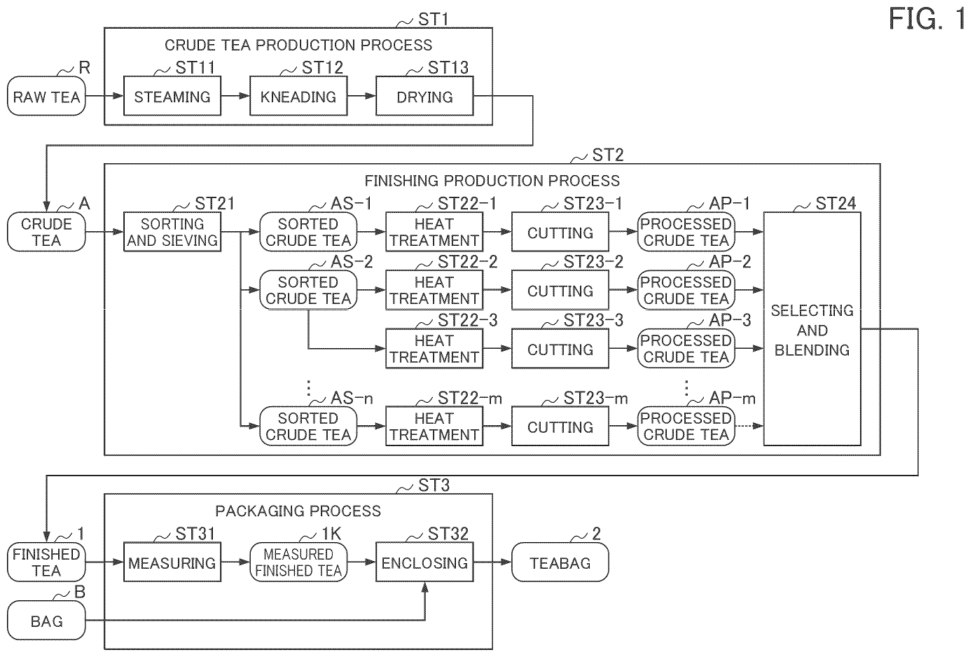

FIG. 1 is a diagram illustrating an overview of the production process for finished tea leaves and teabags enclosing the finished tea leaves, according to one embodiment of the green tea leaves of the present invention.

As illustrated in FIG. 1, the raw tea R undergoes a crude tea production process ST1, a finishing production process ST2, and a packaging process ST3, thereby producing finished tea 1 and teabags 2 enclosing the finished tea 1. The following describes each of the crude tea production process ST1, the finishing production process ST2, and the packaging process ST3.

The crude tea production process ST1 is a process of producing crude tea A from raw tea R.

Here, “raw tea R” refers to a raw material for green tea harvested from tea plants, and the material is in an unheated raw state. The raw tea R processed into tea leaves through fermentation will become oolong tea or black tea leaves, and is no longer usable as green tea leaves. Accordingly, in order to produce green tea and green tea products, the raw tea R is stored in an environment that slows the progress of fermentation. The crude tea production process ST1 is initiated before fermentation of the raw tea R progresses.

“Crude tea A” refers to green tea leaves produced from tea leaves before the finishing process. The enzymes contained in the raw tea R are deactivated through a treatment in the crude tea production process ST1. As a result, the raw tea R is processed into the crude tea A for green tea, which can withstand longer-term storage than the raw tea R. However, the crude tea A is inconsistent in shape, size, and properties (including aroma and taste) compared to green tea leaves distributed to general consumers (e.g., finished tea 1 described later) and has a higher moisture content.

The finishing production process ST2 is a process of producing the finished tea 1 from the crude tea A.

Here, “finished tea 1” is a final product as green tea leaves processed from the crude tea A serving as a raw material through the finishing production process, and is suitable for consumption by general consumers. The finished tea 1 has a shape, size, and moisture content which satisfy predetermined standards, and is distributed to general consumers.

As will be described later in detail, it is important for delicious tea to have a complex aroma and taste. Cold water extraction using conventional green tea leaves cannot extract a complex aroma and taste, and the resulting tea cannot be considered delicious. The finished tea 1 of the present embodiment, produced through the finishing production process ST2 illustrated in FIG. 1, is capable of extracting green tea with a complex aroma and taste.

Next, the packaging process ST3 is a process of enclosing and packaging the finished tea 1 in the bags B to produce teabags 2.

Here, the “bag B” refers to a container serving as the teabags 2 by enclosing the finished tea 1. As will be described later in detail, the bag B of the present embodiment has a substantially regular tetrahedral shape, and is made of a water-permeable mesh material composed of biomass plastic. For example, a biomass plastic such as Soilon (registered trademark) is used.

The “teabag 2” refers to the bag B enclosing the finished tea 1. General consumers can extract green tea by immersing the teabag 2 in cold water.

The following provides a more detailed description of each of the crude tea production process ST1, the finishing production process ST2, and the packaging process ST3.

First, the crude tea production process ST1 will be described. The crude tea production process ST1 includes steaming ST11, kneading ST12, and drying ST13.

The steaming ST11 in the crude tea production process ST1 is a process of heating the raw tea R with steam or the like. The degree of steaming ST11 determines the fundamental characteristics of crude tea A, such as taste, aroma, and color during extraction.

Specifically, for example, the stronger the degree of steaming ST11, the murkier (darker) the color, while bitterness and aroma components are reduced. The “stronger degree of steaming ST11” refers to conditions where the steam temperature or volume is higher, or the duration of exposure to steam is longer. Specifically, for example, the steaming ST11 is carried out using a steaming machine or the like, but may also be carried out manually as appropriate.

The kneading ST12 in the crude tea production process ST1 is a process of kneading the raw tea R that has been treated in the steaming ST11. Through the kneading ST12, the tea leaves become softer, the cells are broken, and the green tea components become more easily extractable. The kneading ST12 may consist of a plurality of sub-processes, such as rough kneading, primary kneading, intermediate kneading, and final kneading. Specifically, for example, the kneading ST12 is carried out using a rough kneading machine, a primary kneading machine, an intermediate kneading machine, or a final kneading machine, but may also be carried out manually as appropriate.

The drying ST13 in the crude tea production process ST1 is a process of drying the raw tea R that has been treated in the kneading ST12, thereby producing crude tea A. Through the crude tea production process ST1 including the drying ST13, the moisture content of the crude tea A is reduced to approximately 5% of that of the raw tea R. As a result, the crude tea A can withstand long-term storage compared to the raw tea R. The drying ST13 is carried out using a drying machine, but may also be carried out manually as appropriate. Through the steaming ST11 to the drying ST13 in the crude tea production process ST1 described above, the crude tea A is produced from the raw tea R. As described above, the raw tea R is treated in the crude tea production process ST1 within a storage environment and timeframe to prevent fermentation. Therefore, the crude tea production process ST1 is promptly carried out near the picking site of the raw tea R.

Some businesses conduct integrated production, from the cultivation of the raw tea R to the manufacture of the finished tea 1 or the teabags 2. However, many businesses that manufacture the finished tea 1 or the teabags 2 procure the crude tea A, and carry out the finishing production process ST2 using the crude tea A thus procured. The following description assumes that the businesses procure the crude tea A and carry out the finishing production process ST2 and the packaging process ST3.

Next, the finishing production process ST2 will be described. The finishing production process ST2 includes sorting and sieving ST21, heat treatments ST22-1 to ST22-m (where m is an integer equal to or greater than n, which will be described later), cutting ST23-1 to ST23-m, and selecting and blending ST24.

The sorting and sieving ST21 in the finishing production process ST2 is a process of sorting the crude tea A to sort those that satisfy predetermined quality standards and sieving the tea leaves by the size. In the example illustrated in FIG. 1, as a result of the sorting and sieving ST21, a single type of crude tea A is sorted into sorted crude teas AS-1 to AS-n (where n is an integer equal to or greater than 2). Hereinafter, when there is no need to distinguish each of the sorted crude teas AS-1 to AS-n individually, the group as a whole is collectively referred to as “sorted crude tea AS”.

Next, the heat treatments ST22-1 to ST22-m in the finishing production process ST2 correspond to what is commonly referred to as a roasting process, in which the sorted crude teas AS-1 to AS-n undergo predetermined heat treatments, respectively. The heat treatments ST22-1 to ST22-m determine the final aroma and taste of the processed crude teas AP-1 to AP-m.

That is, the roasting (heat treatments ST22-1 to ST22-m) is primarily a process of altering the extent to which the green tea leaves (sorted crude tea AS) contain each of the various components responsible for different aromas and tastes. Specifically, for example, as the roasting level increases, the grassy odor, bitterness, and astringency of the green tea leaves decrease, while the Maillard reaction enhances the components responsible for sweetness and roasted aroma. The roasting in the heat treatments ST22-1 to ST22-m breaks down the structure of the sorted crude tea AS, thereby appropriately altering the extent to which each component contained in the processed crude tea AP is extracted.

In the present embodiment, each of the heat treatments ST22-1 to ST22-m is individually adjusted. That is, in the present embodiment, the sorted crude teas AS are roasted at different roasting levels, respectively, in the heat treatments ST22-1 to ST22-m.

The person responsible for adjusting the heat treatments ST22-1 to ST22-m modifies the conditions for the heat treatments ST22-1 to ST22-m, based on the quality of the crude tea A and the sorted crude tea AS, as well as the influence of the cutting ST23-1 to ST23-m and the selecting and blending ST24, which will be described later, and roasts separately.

The term “roasting level” refers to the extent of roasting (heat treatments ST22-1 to ST22-m) applied to the green tea leaves. The phrase “different roasting levels” refers to different properties in roasting levels such as the aroma and taste of the drinking tea extracted. The determination of whether the roasting levels differ for two or more processed crude teas AP can be made through sensory evaluation conducted by a plurality of individuals with prescribed qualifications and experience.

The cutting ST23-1 to ST23-m in the finishing production process ST2 is a process of cutting the sorted crude teas AS, which have undergone the roasting, to predetermined sizes, respectively. The sorted crude teas AS undergo the heat treatments ST22-1 to ST22-m and the cutting ST23-1 to ST23-m, thereby becoming the processed crude teas AP-1 to AP-m, respectively. The cutting ST23-1 to ST23-m results in variations in the sizes of the processed crude teas AP-1 to AP-m. The size of the processed crude tea AP affects which components, such as aroma, taste, and color, are more easily extractable from the processed crude tea AP.

Hereinafter, when there is no need to distinguish each of the heat treatments ST22-1 to ST22-m individually, the group as a whole is collectively referred to as “heat treatment ST22”. Similarly, when collectively referring to “heat treatment ST22”, the cutting ST23-1 to ST23-m and the processed crude teas AP-1 to AP-m are referred to as “cutting ST23” and “processed crude tea AP,” respectively.

Specifically, for example, in the case of the example illustrated in FIG. 1, the sorted crude tea AS-1 undergoes the heat treatment ST22-1 followed by the cutting ST23-1, thereby becoming the processed crude tea AP-1. In other words, the crude tea A undergoes the sorting and sieving ST21, the heat treatment ST22, and the cutting ST23, thereby becoming the processed crude tea AP.

The processed crude teas AP-1 to AP-m are produced through different processes, respectively, including the sorting and sieving ST21, the heat treatment ST22, and the cutting ST23. Thus, the processed crude teas AP-1 to AP-m, which are produced from a single type of crude tea A, have different aromas and tastes, respectively.

Here, FIG. 1 illustrates the processed crude tea AP-2, in which the heat treatment ST22-2 followed by the cutting ST23-2 have been applied to the sorted crude tea AS-2. Additionally, FIG. 1 illustrates the processed crude tea AP-3, in which the heat treatment ST22-3 followed by the cutting ST23-3 have been applied to the sorted crude tea AS-2. That is, the processed crude teas AP-2 and AP-3, which are produced from a single type of sorted crude tea AS-2, exhibit different aromas and tastes, respectively. In this manner, the plurality of processed crude teas AP with different aromas and tastes can be produced from a single type of sorted crude tea AS by carrying out different processes, respectively, including the heat treatments ST22 and the cutting ST23.

Although not illustrated, the plurality of processed crude teas AP with different aromas and tastes can also be produced from the plurality of crude teas A by carrying out different processes, respectively, including the sorting and sieving ST21, the heat treatment ST22, and the cutting ST23.

As described above, the plurality of processed crude teas AP with different aromas and tastes are produced through the sorting and sieving ST21, the heat treatment ST22, and the cutting ST23 as illustrated in FIG. 1.

Next, the selecting and blending ST24 in the finishing production process ST2 is a process of selecting and blending the necessary processed crude teas AP from the processed crude teas AP-1 to AP-m. That is, a business that produces the finished tea 1 or the teabag 2 can select two or more processed crude teas AP from the plurality of processed crude teas AP and blend in a predetermined ratio to obtain the finished tea 1 with a desired aroma and taste.

In the example illustrated in FIG. 1, the arrow leading from the processed crude tea AP-m to the selecting and blending ST24 is represented by a dashed line. This indicates that the business did not select or blend the processed crude tea AP-m. As a result, the finished tea 1 does not contain the processed crude tea AP-m.

Next, the packaging process ST3 will be described. The packaging process ST3 includes measuring ST31 and enclosing ST32.

The measuring ST31 in the packaging process ST3 is a process of measuring the finished tea 1, produced through the finishing production process ST2, in a specified amount to be enclosed in a single bag B. That is, through the measuring ST31, the finished tea 1 is divided into portions of measured finished tea 1K, each corresponding to the amount to be enclosed in a single bag B. As will be described later in detail, the amount of the measured finished tea 1K is an appropriate amount for use in the teabag 2 for cold water extraction.

The enclosing ST32 in the packaging process ST3 is a process of enclosing the measured finished tea 1K, measured in the measuring ST31, into the bag B. This produces the teabag 2 enclosing an appropriate amount of the measured finished tea 1K suitable for cold water extraction. Although not illustrated, the teabag 2 is appropriately packaged and sold to general consumers and others.

Summarizing the above, the finished tea 1 and the teabags 2 containing the finished tea 1 in the present embodiment include the following characteristics.

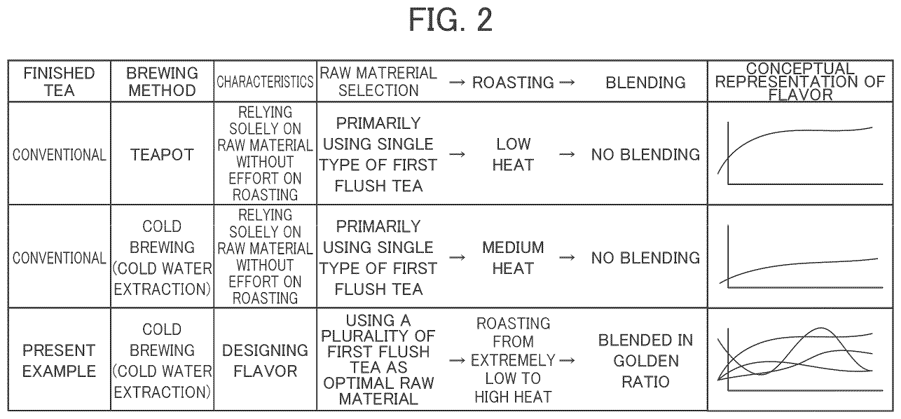

Firstly, the finished tea 1 is characterized as green tea leaves for cold water extraction. As will be described later in detail with reference to FIG. 2, the finished tea 1 is green tea leaves capable of extracting green tea with a complex aroma and taste even with cold water extraction. That is, the finished tea 1 and the teabag 2 enclosing the finished tea 1 are characterized as “for cold water extraction”, and are capable of providing delicious green tea when sold to general consumers. In contrast, when conventional green tea leaves were sold as “for cold water extraction”, the resulting green tea lacked flavor and was not well accepted by general consumers. In other words, conventional green tea leaves, when designated “for cold water extraction”, did not allow consumers to experience the authentic flavor of tea. On the other hand, the finished tea 1 in the present embodiment realizes the Natural-Brew Method (brewing philosophy and technique), allowing the authentic taste of tea to be experienced. Details of the Natural-Brew Method will be described later.

Secondly, the finished tea 1 contains the processed crude teas AP at the plurality of roasting levels. That is, as described above, the finished tea 1 is produced by blending two or more types of processed crude teas AP.

For example, the sorted crude tea AS contains green tea leaves of different sizes. Accordingly, when the plurality of sorted crude teas AS undergo the same conditions in the heat treatment ST22, the roasting levels of the resulting processed crude teas AP will be different. When the same sorted crude tea undergoes the heat treatment ST22 under different conditions, the roasting levels of the resulting processed crude tea AP will naturally be different.

The finished tea 1 in the present embodiment contains such processed crude teas APs at a plurality of roasting levels. As a result, the finished tea 1 provides a complex aroma and taste even with cold water extraction.

Thirdly, the teabag 2 encloses the finished tea 1 suitable for cold water extraction, which is the measured finished tea 1K suitable for cold water extraction. As a result, general consumers can easily enjoy delicious green tea (with a complex aroma and taste) by simply using the teabag 2 in cold water.

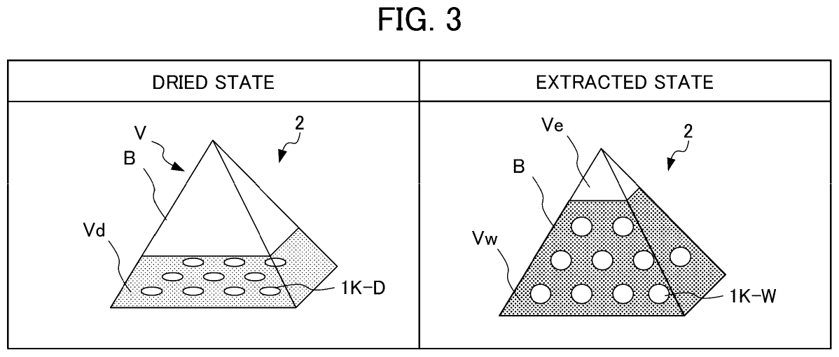

Furthermore, the teabag 2 in the present embodiment encloses the finished tea 1, which is suitable for cold water extraction and has been measured in an amount suitable for cold water extraction. As a result, even with cold water extraction, the teabag 2 is extracted in cold water as green tea with a sufficiently complex aroma and taste. The amount of the finished tea 1 enclosed in the teabag 2 suitable for cold water extraction will be described with reference to FIG. 3.

FIG. 2 is a diagram illustrating the characteristics of cold water extraction of the finished tea 1 illustrated in FIG. 1. The diagram in FIG. 2 depicts the characteristics of: green tea extracted from conventional green tea leaves in a teapot (hot water) ; green tea extracted from conventional green tea leaves in cold water; and green tea extracted from the finished tea leaves of the present embodiment in cold water.

As a premise, green tea leaves contain numerous components responsible for aroma and taste. That is, the components ultimately extracted into the final green tea are determined by both the extent to which the green tea leaves contain numerous components responsible for what aroma and taste, and the extent to which the components are extracted during the green tea extraction process. The extracted numerous components responsible for aroma and taste, along with the balance thereof, ultimately determine the aroma and taste of the extracted green tea.

Roasting (for example, the heat treatment ST22 in FIG. 1) is primarily a process of altering the extent to which green tea leaves contain numerous components responsible for what aroma and taste. Specifically, for example, as the roasting level increases, the grassy odor, astringency, and bitterness of the green tea leaves decrease, while the Maillard reaction enhances the components responsible for sweetness and roasted aroma. However, roasting breaks down the structure of the green tea leaves, thereby appropriately altering the extent to which the components are extracted during the green tea extraction process.

The difference between extraction using a teapot (hot water) and extraction using cold water lies in the extent to which components are extracted during the green tea extraction process. Specifically, for example, when tea is extracted in hot water, such as using a teapot, all the numerous components responsible for aroma and taste contained in the green tea leaves are generally extracted. In contrast, when tea is extracted using cold water, only some portions of the numerous components contained in the green tea leaves are extracted gradually over time. Furthermore, the perception of aroma and taste through the five senses differs depending on whether hot water or cold water is used. In other words, green tea leaves for cold water extraction should have a pleasant aroma and taste as perceived when drinking the green tea in a cold state. Therefore, in the present embodiment, even with cold water extraction, the finished tea 1 gradually releases various components responsible for aroma and taste from the beginning, allowing the drinker to experience a more refined and enhanced perception of flavor through the five senses.

That is, with cold water extraction, among the various components naturally present in green tea leaves, those present in small amounts or those that are difficult to extract in cold water are scarcely extracted. Therefore, the amount of components naturally present in small amounts in green tea leaves can be increased by processing (heat treatment). However, the components conventionally extracted in cold water may decrease by such processing (heat treatment). Accordingly, green tea leaves that have undergone a single process (such as a process at a specific roasting level) using a single type of raw material (crude tea) tend to result in a bland taste.

In other words, as illustrated in FIG. 2, green tea extracted from conventional green tea leaves in a teapot (hot water) has been primarily focused on maximizing the characteristics of the raw material. In other words, no effort was made on roasting, leaving it entirely to the natural characteristics of the raw material. That is, first flush tea leaves were primarily chosen as raw materials. Roasting (heat treatment) was carried out at a low temperature. Furthermore, blending (selecting and blending) was generally not carried out. Any adjustments made after roasting (heat treatment) the tea leaves were merely intended to correct inconsistencies in the roasting (heat treatment). Specifically, for example, when roasting (heat treatment) a specific crude tea, variations in the crude tea or the state of the roaster can result in inconsistencies over time. Accordingly, the crude tea is stirred after roasting, thereby correcting inconsistencies in the roasting (heat treatment). As a result, the finished tea retains the characteristics of the original green tea leaves (crude tea) serving as a raw material. As illustrated in the flavor conceptual diagram of FIG. 2, a single type of tea leaves results in extracting a consistent taste in a short period of time. However, since hot water is used for extraction, all components contained in the green tea leaves are extracted, leading to a complex aroma and taste that reflect the characteristics of the original green tea leaves (crude tea) serving as a raw material.

As illustrated in FIG. 2, green tea extracted from conventional green tea leaves in cold water also shared the same characteristic as the extraction using a teapot described above, where no effort was made on roasting, leaving it entirely to the natural characteristics of the raw material. That is, first flush tea leaves were primarily chosen as raw materials. Roasting (heat treatment) was carried out at a medium temperature. Furthermore, blending (selecting and blending) was not performed. As a result, the finished tea retains the characteristics of the original green tea leaves (crude tea) serving as a raw material. However, in the case of cold water extraction, as illustrated in the flavor conceptual diagram of FIG. 2, aroma and taste are not effectively extracted from a single type of tea leaves, resulting in a bland flavor. In the case where the green tea leaves for a conventional teapot (hot water) extraction are simply extracted in cold water (cold water extraction), the taste thereof will be bland.

On the other hand, as illustrated in FIG. 2, the green tea extracted from the finished tea 1 of the present embodiment (this example) through cold water extraction is designed with the goal of creating a well-balanced flavor (characteristics). That is, in selecting raw materials, the individual blending the finished tea 1 primarily selects and employs a plurality of optimal first flush tea leaves. In this case, roasting (heat treatment) may employ various levels from extremely low heat to high heat. By utilizing the processed crude tea AP that has undergone various levels of roasting (heat treatment), blending can be carried out to achieve an optimal flavor (characteristics).

As a result, the finished tea 1 is composed of a blend of various types of green tea leaves (crude teas) at various roasting levels. Different components are extracted from the plurality of raw materials (crude tea) contained in the finished tea 1 as well as the green tea leaves that have undergone the plurality of treatments (such as processing at predetermined roasting levels) . Consequently, the green tea extracted from the finished tea 1 of the present embodiment in cold water contains a plurality of components, leading to a complex aroma and taste. A complex aroma and taste can be recognized by general consumers as a characteristic of what is called delicious green tea. The complex structure depicted in the flavor conceptual diagram of FIG. 2 conceptually represents the complex aroma and taste. In the present embodiment, each of the plurality of types of tea leaves carries different components, forming a complex structure.

Thus, the finished tea 1, consisting of a blend of various types of green tea leaves (crude tea) at various roasting levels, becomes suited for cold water extraction. The production process of the finished tea 1 and the teabag 2 enclosing the finished tea 1, as illustrated in FIG. 1, is well-suited for blending various green tea leaves (crude tea) at different roasting levels.

That is, in the finishing production process ST2 illustrated in FIG. 1, a single type of sorted crude tea AS undergoes different heat treatments ST22 and different cutting ST23, thereby allowing for producing a plurality of processed crude teas AP with different characteristics. As a result, it is possible to produce the finished tea 1 that maintains the characteristics of a single type of sorted crude tea AS while exhibiting a complex aroma and taste even with cold water extraction.

Even in the case of using a plurality of crude teas AS in the finishing process ST2, the plurality of sorted crude teas AS undergo different heat treatments ST22 and different cutting ST23, thereby allowing for producing a plurality of processed crude teas AP with different characteristics. As a result, it is possible to efficiently produce the processed crude tea AP for producing the finished tea 1 with a complex aroma and taste even with cold water extraction.

Using the example of the teabag 2 in the present embodiment illustrated in FIG. 3, the amount of the finished tea 1 to be enclosed in the teabag 2 will be described.

FIG. 3 is a schematic diagram illustrating the teabag, as illustrated in FIG. 1, in the dried state and the extracted state. The teabag 2 is designed for extraction using 500 mL of cold water, and has a substantially regular tetrahedral shape with an edge length of 7.5 cm. Accordingly, the internal volume V of the bag B is approximately 49.7 cm³.

The teabag 2 in the dried state illustrated in FIG. 3 encloses the measured finished tea 1K in the dried state (hereinafter referred to as “dried enclosed tea leaves 1K-D”).

The mass of the dried enclosed tea leaves 1K-D in the present embodiment is approximately 7 g. This is an optimal amount of finished tea 1 for extraction with 500 mL of cold water over a period of 90 minutes, according to one example of the present embodiment. The volume Vd of 7 g of the dried enclosed tea leaves 1K-D in the present embodiment is 13 cm³.

In the case of using the processed crude tea AP with easily extractable components, or the case where the absolute amount of necessary extracted green tea components is low, the amount of the dried enclosed tea leaves 1K-D may be low. In such cases, the mass of the dried enclosed tea leaves 1K-D may be approximately 6 g.

In the case of fixing the mass of the dried enclosed tea leaves 1K-D to be enclosed in the packaging process ST3, the selecting and blending ST24 may be carried out such that the fixed mass of the dried enclosed tea leaves 1K-D is optimized for extraction with 500 ml of cold water over a period of 90 minutes. As a result, the selecting and blending ST24 can be adjusted such that the amount of the dried enclosed tea leaves 1K-D is not adjusted in the packaging process ST3.

Specifically, for example, assume that a first finished tea 1 is designed for extraction using 500 mL of cold water over 90 minutes. The selecting and blending ST24 is considered for producing a second finished tea 2, in which the processed crude tea AP with easily extractable components is employed, or the absolute amount of necessary components to be extracted in green tea is low. In such cases, when the selecting and blending ST24 is simply carried out, as described above, appropriate extraction can be ensured by adjusting the mass of the dried enclosed tea leaves 1K-D to approximately 6 g. However, even in such cases, the conditions can be made suitable for extraction with 500 mL of cold water over 90 minutes by carrying out the selecting and blending ST24 suitable for extraction with 500 mL of cold water over 90 minutes. This can consequently reduce the labor of adjustments to the factory line when modifying the packaging label of the teabag 2 or the mass of the dried enclosed tea leaves 1K-D in the teabag 2.

Here, the dried enclosed tea leaves 1K-D absorb water and expand when immersed in water. In FIG. 2, the dried enclosed tea leaves 1K-D are depicted as elliptical shapes. The diagram depicts a dried and shrunken state. In the present embodiment, the ratio of the volume of the dried enclosed tea leaves 1K-D before and after immersion in cold water for 90 minutes is approximately 2.8 times. The volume of the green tea leaves after immersion in cold water for 90 minutes is the volume measured after removing the green tea leaves from water and allowing them to drain naturally under their own weight.

The following description assumes that, during extraction, a predetermined surface of the teabag 2 is oriented at the bottom, and another vertex (hereinafter referred to as the “upper vertex”) is oriented upward. Inside the teabag 2 in reality, the measured finished tea 1K (hereinafter referred to as “extraction-phase enclosed tea leaves 1K-W”) during extraction in cold water (in the extraction state) is suspended due to the presence of water between the tea leaves. In FIG. 2, the extraction-phase enclosed tea leaves 1K-W are depicted as circular shapes. The diagram depicts an expanded state due to water absorption.

In the teabag 2 of the present embodiment, during extraction, the green tea leaves generally do not stay in the area above 2.5 cm from the upper vertex, while the green tea leaves stay suspended in the region below 2.5 cm from the upper vertex. The volume Ve of the tetrahedral shape with a height of 2.5 cm is 3.4 cm³. That is, in the suspended state within cold water, the volume Vw of the extraction-phase enclosed tea leaves 1K-W is approximately 46.3 cm³. As a result, the extraction-phase enclosed tea leaves 1K-W do not occupy the 3.4 cm³ volume near the upper vertex of the teabag 2, thereby ensuring what is called the swimming space for tea leaves. It has been described that green tea leaves generally do not stay in the region above the height h=2.5 cm from the top vertex. However, in some cases, certain green tea leaves may be completely suspended at the top vertex of the teabag 2, depending on the condition of the green tea leaves and the air adhering thereto. Specifically, for example, tea stems forming so-called “tea pillars” or “tea powder” may stay suspended at the upper vertex of the teabag 2.

In the present embodiment, the volume Ve of the swimming space for tea leaves is approximately 3.4 cm³ out of the 49.7 cm³ volume of the teabag 2, corresponding to approximately 6.8% of the volume V of the teabag 2. The swimming space for tea leaves should preferably be at least 5% of the volume V of the teabag 2. This secures the swimming space for green tea leaves, allowing components in the measured finished tea 1K to be properly extracted into the drinking green tea.

The swimming space for tea leaves should preferably be no more than 10% of the volume V of the teabag 2. This ensures that the appropriate amount of drinking green tea can be extracted from a single teabag 2.

The swimming space for tea leaves should preferably be between 5% and 10% inclusive of the volume V of the teabag 2. This ensures that the appropriate amount of drinking green tea can be extracted from a single teabag 2, while securing the swimming space for green tea leaves, allowing components in the measured finished tea 1K to be properly extracted into the drinking green tea.

The volume of the dried enclosed tea leaves 1K-D should preferably be between 25% and 35% inclusive of the volume (capacity) V of the teabag 2. In many cases of the finished tea 1, this secures the volume Ve for the swimming space for tea leaves, while allowing the appropriate amount of drinking green tea to be extracted from a single teabag 2.

Depending on the contents of the processed crude tea AP included in the finished tea 1, the dried enclosed tea leaves 1K-D may expand within a range of approximately 2.5 to 3.0 times the original size. Even as a result of the expansion of the dried enclosed tea leaves 1K-D due to water absorption, the swimming space for tea leaves should preferably remain secured.

As described above, the teabag 2 of the present embodiment is suitable for cold water extraction and contains an appropriate amount of the finished tea leaves 1 enclosed therein. Furthermore, with the aforementioned amount, green tea can be extracted in approximately 90 minutes using 500 ml of cold water. General consumers may also rapidly extract the tea by shaking the container after placing the teabag 2 in cold water.

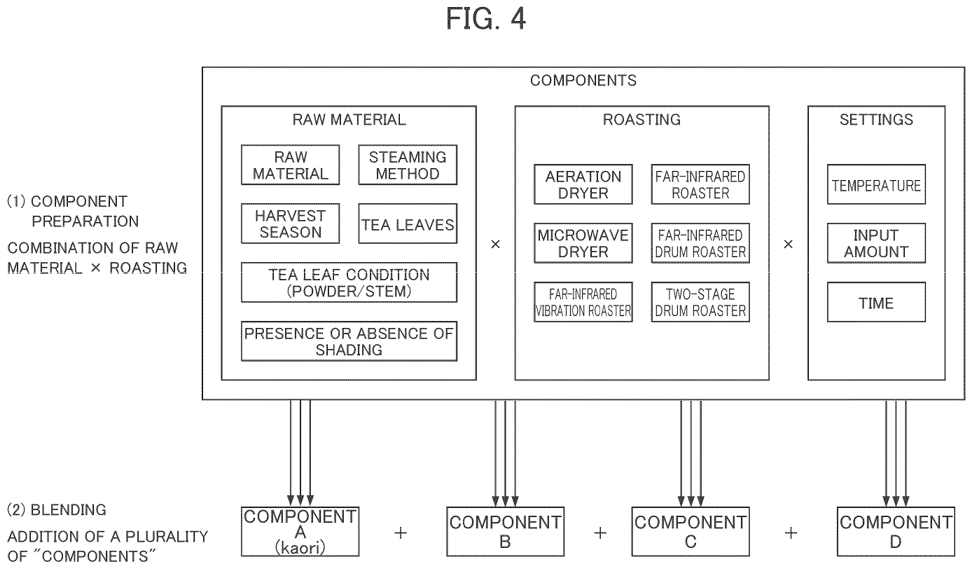

Next, the selecting and blending process for the finished tea 1 illustrated in FIG. 1 will be described. FIG. 4 is a diagram illustrating the preparation of parts and the blending in the selecting and blending process for the finished tea.

As described above, in order to achieve the complex characteristics (aroma and taste) of the finished tea 1, a plurality of processed crude teas AP should be selected and blended. That is, consideration is given to both the preparation of part (processed crude teas AP) constituting the finished tea 1 and the blending (selecting and blending ST24) of parts (processed crude teas AP).

As illustrated in FIG. 4, in the preparation of parts (processed crude teas AP), factors such as origin, harvest season, steaming method, tea leaves, tea leaf state (powder/stem), and shading are considered for the raw material (crude tea A). Equipment for roasting (heat treatment ST22) includes aeration dryers, far-infrared roasters, microwave dryers, far-infrared drum roasters, far-infrared vibration roasters, and two-stage drum roasters. Settings for roasting (heat treatment ST22) include factors such as temperature, input amount, and duration.

Thus, in the preparation of parts (processed crude teas AP), various processing is possible by combining factors such as selecting the crude teas A, or selecting and setting the equipment for the heat treatment ST22. On the other hand, as described above, a single type of processed crude tea AP resulting from specific processing has both components that are easily extracted and components that are difficult to extract. Focusing on this, the blending (selecting and blending ST24) is carried out.

Specifically, for example, parts (processed crude teas AP) responsible for various characteristics are combined and balanced, including the top aroma (part A in FIG. 4), the first body (part B in FIG. 4), the second body (part C in FIG. 4), color (part D in FIG. 4), and clarity. As a result, the finished tea 1 with complex characteristics can be obtained.

Hereinafter, a specific example will be used to describe the characteristics of the parts (processed crude tea AP) obtained through what type of roasting (heat treatment ST22) of what type of crude tea AP, and how the parts are blended to produce the finished tea 1 with complex characteristics. That is, by blending (selecting and blending) the parts (processed crude tea AP) as described below, the flavor is designed, resulting in the production of the finished tea 1 and teabags 2 with complex characteristics, ensuring favorable aroma and taste perceived by those who drink the green tea in a cold state.

The “top” refers to the initial impression when drinking the tea. For the top part (processed crude tea AP), a processed crude tea AP at a high roasting level (strong heat treatment ST22), with a large leaf size resulting from the cutting ST23, is selected. This imparts a sweet and toasty aroma at the beginning of the drinking experience. Next, the “body” refers to the sensation while drinking. For the first body part (processed crude tea AP), a tea at a roasting level (weaker heat treatment ST22) lower than that of the top part, with a finer size than that of the top part resulting from the cutting ST23, is selected. This provides richness while drinking.

Furthermore, for the second body part (processed crude tea AP), a processed crude tea AP at a roasting level (weaker heat treatment ST22 being) lower than that of the top part and different from that of the first body, with a size finer than that of the top part resulting from the cutting ST23, is selected. As a result, different components are extracted from the first and second body components, further enhancing the depth of richness while drinking. That is, by including two body parts (processed crude teas AP), a complex aroma and taste are achieved.

Additionally, for the color part (processed crude tea AP), a tea with a size finer than that of the top and body parts resulting from the cutting ST23, is selected. This ensures that the green color of the tea leaves is effectively extracted, resulting in an aesthetically pleasing green tea.

Furthermore, for the clarity part and the first body part (processed crude tea AP), a tea at a lower roasting level (weaker heat treatment ST22) lower than that of the top part, with the finest size resulting from the cutting ST23, is selected. This results in the finished tea 1 with astringent and bitter components extracted. Astringent and bitter components can be derived from a lower roasting level. Finer tea leaves can extract more astringent and bitter components. By extracting an appropriate level of astringency and bitterness, the tea achieves both richness and a well-balanced clarity (appropriate clarity).

In the above description, the effects of the size of part (processed crude tea AP) have been described based on the assumption that the size variations result from the cutting ST23; however, this is not particularly limited. That is, the size variations of the processed crude tea AP arise not only as a result of the cutting ST23 but also due to other processes such as the initial size variations of the crude tea A and the sorted crude tea AS, and even as a result of the heat treatment ST22 and other processes. In other words, the selecting and blending ST24 should take into account the size variations of the processed crude tea AP, which are not solely determined by a result of the cutting ST23. Thus, the cutting ST23 may not be carried out in the finishing production process ST2.

As described above, by producing the processed crude teas AP with different characteristics through different levels of roasting (heat treatment ST22) and then selecting and blending the teas, the finished tea 1 with a complex aroma and taste can be achieved.

Furthermore, the finished tea 1 is for cold water extraction and is characterized by being produced from a single type of crude tea A, while also characterized by a complex aroma and taste.

The finished tea 1 and the teabag 2 should preferably be characterized as green in color and be extracted with cold water. That is, general consumers do not perceive green tea, based on a broad (and industrially defined) standard that includes roasted green tea, but often distinguish green tea and roasted green tea as separate categories. Specifically, for example, when general consumers simply refer to “green tea,” the term is often understood as the drinking green tea. In other words, by including a color part (processed crude tea AP) in the selecting and blending ST24, the finished tea 1 and the teabag 2 capable of extracting the drinking green tea can be obtained.

In the case of allowing the green-colored green tea to be extracted in cold water, all the processed crude teas AP used for the finished tea 1 and the teabag 2 should preferably be at a roasting level lower than the roasting level for producing roasted green tea. That is, general consumers do not perceive green tea, based on a broad (and industrially defined) standard that includes roasted green tea, but often distinguish green tea and roasted green tea as separate categories. Specifically, for example, when general consumers simply refer to “green tea,” the term is often perceived as tea that does not exhibit the characteristic roasted aroma of roasted green tea. In other words, by including a color part (processed crude tea AP) in the selecting and blending ST24, the finished tea 1 and the teabag 2 can extract tea that does not exhibit the characteristic roasted aroma of roasted green tea.

The processed crude teas AP used for the finished tea 1 and the teabag 2 should preferably employ a high roasting level (strong heat treatment ST22) that is lower than the roasting level of roasted green tea. This imparts a sweet and toasty aroma at the beginning of the drinking experience.

The roasting level for producing roasted green tea refers to a roasting level in the heat treatment ST22, in which high-temperature roasting induces the Maillard reaction, resulting in a change in color and causing the extracted drinking tea to become brown. Whether the roasting level of the processed crude tea AP is lower than the roasting level for producing roasted green tea can be determined by sensory evaluations conducted by a plurality of qualified and experienced individuals.

The finished tea 1 of present embodiment has been described as achieving the Natural-Brew Method (brewing philosophy and technique), allowing the authentic taste of tea to be experienced. Here, the brewing philosophy and technique of the Natural-Brew Method will be described. The Natural-Brew Method is a philosophy based on the combination of natural temperature and time, and also represents a brewing process. The finished tea 1 of the present embodiment and the teabag 2 enclosing the finished tea 1 are excellent products that bring out the true flavor as intended by nature, while allowing for easy preparation, through the aforementioned producing process. The finished tea 1 of the present embodiment and the teabag 2 enclosing the finished tea 1 are capable of extracting green tea with a complex aroma and taste even in a table environment (room temperature) or a cooler environment (cold temperature), specifically through cold water extraction (using cold water at 25° C. or lower). Furthermore, as described above, since the green tea with a complex aroma and taste can be extracted even through cold water extraction (using water at 25° C. or lower), consistently perfect, subtly refined, and delicious taste and aroma can be enjoyed without the need for strict control over extraction time or temperature. In other words, through the Natural-Brew Method, which is based on the combination of natural temperature and time, the true depth of flavor as intended by nature can be extracted, while allowing individuals to slowly reconnect with nature, enabling the experience of green tea flavor in the pure (natural) form.

Although embodiment of the present invention has been described above, the present invention is not limited to the above embodiment, and modifications and improvements within the scope of achieving the purpose of the present invention are also included in the present invention.

The green tea leaves, to which the present invention is applied, only need to include the following configuration, and can adopt various embodiment. That is, the green tea leaves, to which the present invention is applied, are:

green tea leaves for cold water extraction (for example, the finished tea 1 illustrated in FIG. 1), in which the green tea leaves include:
first green tea leaves of a first roasting level (for example, the processed crude tea AP-1 illustrated in FIG. 1) ; and
second green tea leaves of a second roasting level higher than the first roasting level (for example, the processed crude tea AP-2 illustrated in FIG. 1). As a result, the green tea leaves for cold water extraction exhibit complex characteristics, while being designed for cold water extraction.

The second roasting level can be set lower than a roasting level for turning the second green tea leaves into roasted green tea. As a result, the green tea leaves for cold water extraction do not have the characteristic roasted aroma of roasted green tea. The color of the extracted tea remains green without a reddish tint. This enhances appeal to general consumers when marketed as “green tea leaves for cold water extraction”, provided that the extracted tea exhibits a characteristic green color associated with green tea.

One or more additional types of green tea leaves may be further included, in which the roasting levels thereof are different from both the first roasting level and the second roasting level, and also different roasting level from each other. As a result, the green tea leaves for cold water extraction can exhibit even more complex characteristics.

The production method, to which the present invention is applied, is

a method of producing green tea leaves for cold water extraction, in which the method includes:
a first roasting step of roasting tea leaves at a first roasting level, thereby obtaining first green tea leaves;
a second roasting step of roasting tea leaves at a second roasting level that is higher than the first roasting level, thereby obtaining second green tea leaves; and
a blending step of blending the first green tea leaves and the second green tea leaves. As a result, green tea leaves for cold water extraction with complex characteristics can be efficiently produced.

That is, the teabag, to which the present invention is applied, is

a teabag for cold water extraction, enclosing green tea leaves in a dried state, in which
the volume of the dried green tea leaves in the dried state is between 25% and 35% inclusive of the total capacity of the teabag. As a result, during cold water extraction, the green tea leaves inside the teabag do not completely occupy the internal space of the teabag, allowing the leaves to swim, ensuring that the plurality of characteristics of the green tea leaves are appropriately extracted.

During cold water extraction, the volume of the green tea leaves remains at or below 95% of the total volume of the teabag. This ensures that there is a sufficient amount of green tea that can be extracted from a single teabag.

### EXPLANATION OF REFERENCE NUMERALS

1: finished tea
2: teabag
R: raw tea
A: crude tea
AS, AS-1 to AS-n: sorted crude tea
AP, AP-1 to AP-m: processed crude tea
1K: measured finished tea
1K-W: dried enclosed tea leaves
1K-D: extraction-phase enclosed tea leaves
B: bag
ST1: crude tea production process
ST11: steaming
ST12: kneading
ST13: drying
ST2: finishing production process
ST21: sorting and sieving
ST22, ST22-1 to ST22-m: roasting
ST23, ST23-1 to ST23-m: cutting
ST24: selecting and blending
ST3: packaging process
ST31: measuring
ST32: enclosure
V, Vd, Ve: volume

1. A green tea leaf for cold water extraction, comprising:
a first green tea leaf of a first roasting level; and
a second green tea leaf of a second roasting level higher than the first roasting level.

2. The green tea leaf according to claim 1, wherein the second roasting level is lower than a roasting level at which the second green tea leaf becomes roasted green tea.

3. The green tea leaf according to claim 1 , further comprising one or more green tea leaves of roasting levels different from both the first roasting level and the second roasting level, and different roasting level from each other.

4. A method of producing a green tea leaf for cold water extraction, the method comprising:
a first roasting step of roasting a tea leaf at a first roasting level, thereby obtaining a first green tea leaf;
a second roasting step of roasting a tea leaf at a second roasting level higher than the first roasting level, thereby obtaining a second green tea leaf; and
a blending step of blending the first green tea leaf and the second green tea leaf.
